(19) United States
(12) Patent Application Publication
(10) Pub. No.: US 2022/0358375 A1
(43) Pub. Date: Nov. 10, 2022

(54) INFERENCE OF MACHINE LEARNING MODELS

(71) Applicant: International Business Machines Corporation, Armonk, NY (US)

(72) Inventors: James Liam Finnie, Boeblingen (DE); Toni Bollinger, Weil der Stadt (DE); Oliver Schiller, Dettingen (DE); Thomas Friedhelm Böhme, Boeblingen (DE); Tobias Kevin Fränzel, Tuebingen (DE)

(21) Appl. No.: 17/307,109

(22) Filed: May 4, 2021

(51) Int. Cl. G06N 5/04; G06N 20/00

(52) U.S. Cl. CPC G06N 5/04; G06N 20/00

(57) ABSTRACT

Inference results of a machine learning model and associated inputs are collected. An inference request is received. A determination is made whether a request input of the inference request matches at least one collected input of a set of collected inputs. In response to determining that the request input matches at least one collected input in the set of collected inputs, an inference result is determined using one or more collected inference results associated with said one or more matching inputs in the set of collected inputs.

### BACKGROUND

The present invention relates to the field of digital computing systems, and more specifically, to a method for inference of a machine learning model.

Machine learning (ML) is the study of computer algorithms that improve automatically through experience and by the use of data. It is seen as a part of artificial intelligence. Machine learning algorithms build a model based on sample data, known as “training data”, in order to make predictions or decisions without being explicitly programmed to do so. Machine learning algorithms are used in a wide variety of applications, such as email filtering, transaction processing, and computer vision, where it is difficult or unfeasible to develop conventional algorithms to perform the needed tasks. A subset of machine learning is closely related to computational statistics, which focuses on making predictions using computers; but not all machine learning is statistical learning. The study of mathematical optimization delivers methods, theory, and application domains to the field of machine learning. Data mining is a related field of study, focusing on exploratory data analysis through unsupervised learning. ML inference is the process of running live data points into a machine learning algorithm (or “ML model”) to calculate an output such as a single numerical score. This process is also referred to as “operationalizing an ML model” or “putting an ML model into production.” When an ML model is running in production, it is often then described as artificial intelligence (AI) since it is performing functions similar to human thinking and analysis. Machine learning inference basically entails deploying a software application into a production environment, as the ML model is typically just software code that implements a mathematical algorithm. That algorithm makes calculations based on the characteristics of the data, known as “features,” in the ML vernacular.

### SUMMARY OF THE INVENTION

Various embodiments of the present invention provide a method, computer system and computer program product for inference of a machine learning model. In one embodiment, inference results of a machine learning model and associated inputs are collected. An inference request is received. A determination is made whether a request input of the inference request matches at least one collected input of a set of collected inputs. In response to determining that the request input matches at least one collected input in the set of collected inputs, an inference result is determined using one or more collected inference results associated with said one or more matching inputs in the set of collected inputs.

In one aspect, the invention relates to a computer implemented method for inference of a machine learning model. The method comprises an inference assessment comprising: (i) collecting inference results of the machine learning model and associated inputs; (ii) receiving an inference request; (iii) determining if a request input of the inference request matches at least one collected input of the collected inputs; (iv) in response to the request input having one or more matching collected inputs in the collected inputs, determining an inference result using one or more collected inference results associated with said one or more matching collected inputs; and (v) in response to the requested input not having one or more matching collected inputs in the collected inputs, obtaining an inference result from the machine learning model by providing the request input to the machine learning model.

In another aspect, the invention relates to a computer program product comprising a computer-readable storage medium having computer-readable program code (i.e., program instructions) embodied therewith, the computer-readable program code configured to implement all of the steps of the above computer implemented method according to preceding embodiments.

In another aspect, the invention relates to a computer system being configured for: (i) collecting inference results of a machine learning model and associated inputs; (ii) receiving an inference request; (iii) determining if a request input of the inference request matches at least one collected input of the collected inputs; (iv) in response to the request input having one or more matching collected inputs in the collected inputs, determining an inference result using one or more collected inference results associated with said one or more matching collected inputs; and (v) in response to the requested input not having one or more matching collected inputs in the collected inputs, obtaining an inference result from the machine learning model by providing the request input to the machine learning model.

### BRIEF DESCRIPTION OF THE DRAWINGS

Embodiments of the present invention are explained in greater detail, by way of example only, making reference to the drawings in which:

FIG. 1 is a block diagram of a computer system, in accordance with an embodiment of the present invention;

FIG. 2 is a flowchart of a method for inference of a machine learning model, in accordance with an embodiment of the present invention;

FIG. 3 is a flowchart of a method for collecting inference results, in accordance with an embodiment of the present invention;

FIG. 4 is a flowchart of a method for inference of a machine learning model, in accordance with an embodiment of the present invention;

FIG. 5 is a flowchart of a method for inference of a machine learning model, in accordance with an embodiment of the present invention; and

FIG. 6 represents a computerized system, suitable for implementing one or more method steps as involved in the present invention, in accordance with an embodiment of the present invention.

### DETAILED DESCRIPTION

The descriptions of the various embodiments of the present invention will be presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Machine learning models such as neural networks can provide superior solutions for many computer tasks such as image classification; further, ML models are being integrated into many software systems such as database transaction processing systems. The amount of computation needed by ML models such as for large artificial intelligence (AI) systems may be enormous and software systems may need to wait a significant period of time before an inference result is returned thus impeding the introduction of ML models as a service. This means that the inference running time may be very long and the overall performance of the software system is negatively impacted. In addition, as the machine learning model may be provided as a remote service, this may further increase the time required to obtain the inference results. The present invention solves this issue by using previously obtained inference results to generate an approximation of a result for new a inference request. This reduces the time required to obtain inference results regardless of the structure of the machine learning model. That is, the present invention improves the response time without having to increase the speed of the model itself. This may be advantageous as it may enable the use of more elaborate models with the present invention and thus, provide more accurate inference results (e.g., the more elaborate the model, the more accurate it is). In addition, the machine learning model may be provided as a remote or local service and it may be stored on the same machine where the present method is executed. The present invention may further be advantageous as it may support using models more frequently in the computer system, using models in more performance-critical areas of the computer system, and using multiple different models in the computer system (where each separate model would have its own nearest-neighbor inference lookup, for example).

Collecting the inference results and associated inputs may comprise storing the inference results and associated inputs to a storage device. The collecting may, for example, be performed offline and/or during execution of the inference assessment method. The matching of the request input with the collected inputs may be an exact or an approximated matching. The matching maybe performed using an approximate string matching, for example, based on Hamming or edit distance. This may result in K closest collected inputs (e.g., K=1).

The matching may, in another example, be performed using a nearest neighbor search technique. The nearest neighbor search may search for the K closest collected inputs (i.e., the most similar inputs) to the request input of the inference request, where K≥1. In addition, the distance of each of the K closest collected inputs to the request input may be compared with a threshold value (or threshold distance), resulting in J closest collected inputs having a distance smaller than the threshold value, where 0≤J≤K. The matching may be successful or unsuccessful. The matching is successful if at least one collected input (i.e., J≥1) may be identified as matching the request input. In case of a successful matching, the inference result of the request input may be estimated or generated from the inference result(s) associated with the J matching collected input(s). In case J=1, the estimated inference result of the request input may be the inference result of the single matching collected input. In case J>1, the estimated inference result of the request input may, in one example, be the inference result of the closest matching collected input of the J matching collected inputs. Further, in case J>1, the estimated inference result of the request input may, in another example, be a combination of the J inference results of the J matching collected inputs. The combination of the J inference results may, for example, be the average or weighted sum of the J inference results or any other form of combinations that enables obtaining a result that represents the J inference results.

The collection of the inference results and associated inputs as described herein may be particularly advantageous for many types of machine learning models as similar input data may return similar inference results. For example, for a linear regression model, the input features {0.5, 0.8, 0.99} may result in a predicted value of ‘0.012’, whereas input features {0.499, 0.799, 0.999} may result in a predicted value of ‘0.012001’. These two inputs are not the same but are close to each other, and their inference results are similar. Thus, using the approximated matching and the collected results may be advantageous to prevent inferring the machine learning model twice for these two inputs.

The term “machine learning” refers to a computer algorithm used to extract useful information from training data by building probabilistic models (referred to herein as machine learning models) in an automated way. The machine learning may be performed using one or more learning algorithms such as linear regression, k-means, classification algorithm, reinforcement algorithm, gradient descent for a deep neural network, etc. A “model” may, for example, be an equation or a set of rules that makes it possible to predict an unmeasured value from other known values and/or to predict or select an action to maximize a future reward (or minimize a future penalty).

According to one embodiment, in response to the request input having a matching collected input which is not perfectly identical to the matching collected input, asynchronously (i.e., in time) obtaining an inference result from the machine learning model by providing as input to the machine learning model the request input and adding the obtained inference result and the request input to the collected results and collected inputs. Adding the obtained inference result and the request input to the collected results and collected inputs comprises storing the obtained inference result and the request input in the storage device where the collected inference results and collected inputs are stored. This may result in updated collected inference results and inputs. The updated collected inference results and inputs may be used for a subsequent received inference request. Thus, when there is no exact matching between the request input and the collected inputs, this embodiment may provide asynchronously obtaining the inference result of the request input and then storing said result. Asynchronously obtaining the inference result may comprise obtaining the inference result at a predefined point of time (e.g., at a time when the machine learning model is not frequently used). This embodiment may enable an asynchronous inference that does not require real-time interaction; instead, the inference result can be obtained when it is best suitable for the computing system. This embodiment may further have the advantage of self-improving the inference result estimation by dynamically updating the storage of the collected inputs and the associated inference results.

According to another embodiment, in response to the request input having no match in the collected inputs (i.e., the matching is unsuccessful), the obtained inference result from the machine learning model may be added to the collected inference results in association with the request input. This embodiment may have the advantage of self-improving the inference result estimation by dynamically updating the storage of the collected inputs and the associated inference results.

According to yet another embodiment, obtaining the inference result is performed by a dedicated asynchronous task processor which is distinct from a processor performing the inference assessment. This embodiment may be advantageous as it may enable the use of a multi-processor system, where several processors may be provided, each with different capabilities depending on the importance of the tasks they execute. This embodiment may optimize the execution of the inference requests by, for example, prioritizing the usage of the processors for different requests or tasks.

According to yet another embodiment, determining whether the request input matches at least one collected input comprises: computing a distance between the request input and the collected inputs, wherein in response to a distance of the computed distances being smaller than a threshold value, the request input matches the collected input having said distance to the request input. For example, when inputs are numerical values, the computed distance may be the Euclidean distance or the Manhattan distance.

According to yet another embodiment, the method further comprises providing an algorithm. The algorithm is configured to receive as input the collected inputs and the request input, and to identify K closest collected inputs of the request input, wherein determining whether the request input matches at least one collected input comprises: in response to the distance of J closest collected inputs of the K closest collected inputs to the request input being smaller than a threshold value, there is a matching; otherwise there is no matching, where J≤K, wherein in in response to a match determining the inference result of the request input comprises: selecting one of the J collected inference results associated with the J closest collected inputs or combining the J collected inference results.

When a new machine learning model inference request arrives, the provided algorithm may be used to find the closest previous request(s), and if the computer system determines that the input features of the new request are within an allowable threshold distance from the input features of a cached (i.e., closest previous) request, the closest match may be returned instead of issuing a new machine learning model request. Optionally, if the closest matching request is not an exact match, the current set of input features can then be sent as an asynchronous machine learning model request such that the new inference result can be added to the list of all cached results, in order to improve upon future requests.

The provided algorithm may improve performance. In particular, unsupervised clustering can be performed easily and efficiently directly within the computer system that executes the present invention, and so the computer system can quickly determine if it is worth waiting an extended period of time for a machine learning model inference system to process the new request and return results. By using clustering instead of a direct cache implementation, similar input requests (not only requests that are exactly identical) can benefit from the cache, under the assumption that the machine learning model will return similar inference results if the input features are similarly close.

According to one embodiment, the algorithm is a k-Nearest Neighbors algorithm. This may be particularly advantageous when the model is a regression model, because the algorithm enables a regression approach to find the closest matches, and then uses a combination of the closest matches to determine the output regression value.

According to another embodiment, the algorithm is a clustering algorithm. The clustering algorithm may, for example, comprise a k-means algorithm. This may be advantageous when the model is a classification model. The algorithm may, for example, be configured to find the K closest clusters of matches and where K≥1, select the J closest clusters that have a distance smaller than the threshold value, where J≤K, and then use the most frequent label from each cluster as the estimated inference result of the cluster. The J estimated inference results may be combined as described above when J>1; otherwise, if J=1, the estimated inference result may be provided as the inference result of the received input.

According to an embodiment, the method further comprises: in response to a match, asynchronously obtaining an inference result of the request input from the machine learning model, dynamically changing the threshold value based on the difference between the determined inference result and the asynchronously obtained inference result, and using the changed threshold value for determining the inference result of a further received inference request.

According to the embodiment, changing the threshold value comprises increasing or decreasing the threshold value.

These embodiments may enable automatic tuning of the threshold value as more inference requests are processed. For example, if after receiving the model inference results, a small difference in inputs translates to a large difference in inference results, the threshold value may be decreased in the next iteration (i.e., a new request must be much closer to an existing point to be considered a match). If a large difference in input distance results in a very small difference in inference results, the threshold value may be increased. This allows for much easier configuration. This also allows for learning—the model improves inference fidelity over time as it adjusts the threshold distance.

According to an embodiment, collecting the inference results is performed such that a minimum number of inference results is collected. This further improves the response time as the probability of matching increases with a higher number of collected inputs and inference results.

According to another embodiment, the minimum number of inference results is one. This is particularly advantageous for dynamic updating of the collected inputs and associated inference results. That is, after collecting one input and an associated inference result, the matching step and following steps of the present method may be performed using the collected inputs and inference results.

According to another embodiment, the collected inference and associated collected inputs are stored in a cache. Using a cache may further reduce the time required to obtain inference results.

According to one embodiment, the machine learning model is provided as a remote service, wherein obtaining an inference result comprises communicating the request input to the machine learning model via an interface and receiving via the interface the inference result. The interface may, for example, be a REST API (Representational State Transfer Application Programming Interface).

According to one embodiment, the method further comprises: in response to determining that the request input has a data format different from a data format of the collected inputs, the data format of the request input is transformed into the data format of the collected inputs, wherein the matching is performed between the transformed request input and the collected inputs by comparing the transformed input and the collected inputs. The data format may, for example, be a number format. In response to the request input having a number format, the transformation of the request input may, for example, comprise rounding the request input. The transformation may have a transformation error indicative of a tolerable difference between the transformed request input and the request input.

According to one embodiment, determining whether the request input matches at least one collected input comprises: providing an upper threshold value and a lower threshold value; computing a distance between the request input and the collected inputs; and (i) in response to a distance of the computed distances being smaller than or equal to the lower threshold value, determining that the request input matches exactly the collected input having said distance to the request input; (ii) in response to a distance of the computed distances being between the lower threshold value and the upper threshold value, determining that the request input matches approximately the collected input having said distance to the request input; and (iii) in response to a distance of the computed distances being higher than the upper threshold value, determining that the request input does not match the collected input.

The upper threshold value is greater than the lower threshold value. The lower threshold value may, for example, be the rounding error. The upper threshold value may, for example, be defined by a user. For example, the collected input may be an exact match of the request input if the distance between them is not larger than the rounding error and the collected input may be an approximate match if said distance is larger than the rounding error and smaller than or equal to the upper threshold value. The collected input may not be considered a match if said distance is larger than the upper threshold value.

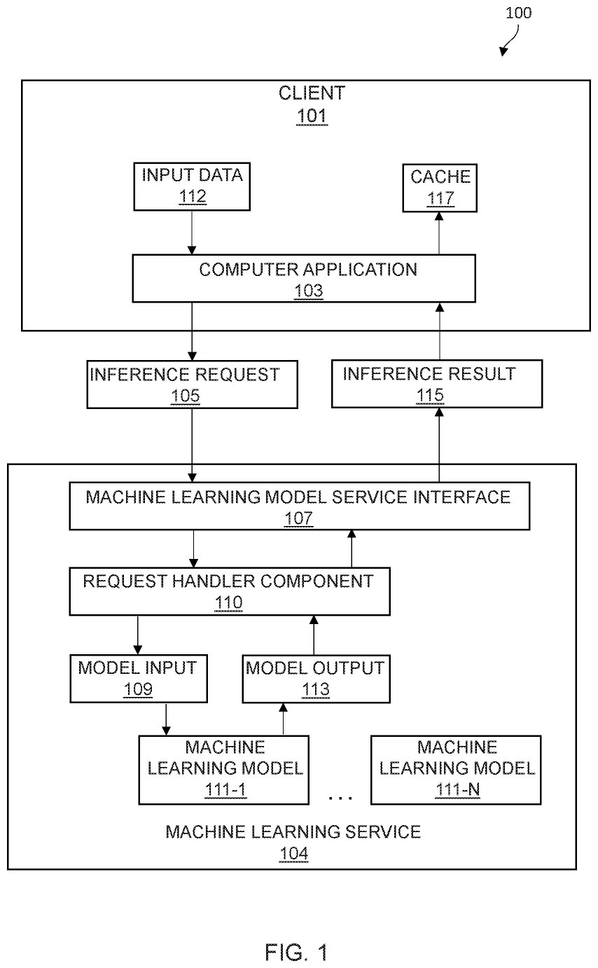

FIG. 1 illustrates computer system 100 in which inference results are generated by machine learning service 104 in response to a client request, according to an embodiment of the present invention. Machine learning service 104 may be hosted by a separate machine that is remotely connected to client 101 of computer system 100. Client 101 may also be referred to as core software system. Computer system 100 may operate in accordance with a representational state transfer (REST) architecture and enable a web service that conforms to the REST architectural style.

Machine learning service 104 may comprise any number of trained machine learning model 111-1; for example, machine learning model 111-1, machine learning model 111-2 (not shown in FIG. 1), and machine learning model 111-N (for ease of reading, any instance of machine learning model 111-1 will be referred to as machine learning model 111-N throughout this paper), request handler component 110 and machine learning model service interface 107. Machine learning model service interface 107 may, for example, be an application programming interface (API) such as REST API. Each machine learning model 111-N may be implemented in software and/or hardware. For example, the machine learning model may be implemented in specialized hardware such as graphics processing units (GPUs) or tensor processing units (TPUs).

Client 101 comprises computer application 103 and cache 117. Computer application 103 may be configured to receive user requests for performing inference of one or more machine learning models. The user request may, for example, include input data 112. Upon receiving the user request, computer application 103 may submit inference request 105 via machine learning model service interface 107 for obtaining inference results for input data 112. Inference request 105 may include, for example, an indication (e.g., file names, paths, or identifiers) of input data 112.

Request handler component 110 of machine learning service 104 may process inference request 105 in order to select one or more of machine learning model 111-N for which the inference request is destined. This may, for example, be performed by processing the input data in order to find the machine learning model that is adapted to receive and process that specific type of input data. In another example, the received inference request may further comprise an indication of the machine learning model to be used. Request handler component 110 may input model input 109 to the selected machine learning model 111-N. In an embodiment, model input 109 may be the received input data or model input 103 may be obtained by adapting the format of the received input data in order to obtain input in a format that can be processed by the selected machine learning model. The selected machine learning model may process model input 109 and provide model output 113 which is an inference result of inferring model input 109. Model output 113 is provided by request handler component 110 as inference result 115 via request handler component 110 and machine learning model service interface 107 to computer application 103. In response to receiving inference result 115, computer application 103 may cache inference result 115 to cache 117 in association with input data 112 and model input 109. Thus, by processing multiple user requests, computer application 103 may collect pairs of input data and corresponding inference results in cache 117.

Client 101 and machine learning model service interface 107 are shown as separate components, however, machine learning model service interface may be part of client 101 in another embodiment.

In the computer system of FIG. 1, client 101 may typically communicate with machine learning service 104 using REST APIs, for example, by sending a request to the service, and waiting for the service to provide results. As client 101 and machine learning service 104 of computer system 100 may be on separate physical machines, this REST request may take a considerable amount of time, particularly in relation to the speed at which client 101 is expected to operate. Client 101 may not have a-priori knowledge about what inference result will be returned for a particular machine learning model request. However, if the designers of client 101 have determined that the machine learning model results should be similar when the input features of the request(s) are similar, the present invention may advantageously be used. Here, client 101 may implement a nearest neighbour type of classification or regression algorithm to be able to group similar input requests, and to devise some mechanism of knowing whether similar inputs are ‘close enough’ that it is acceptable to return the machine learning model inference result from a close neighbour.

The first time a machine learning model inference result is requested, client 101 may have no state and thus, there will be no neighbours in cache 117 to search, therefore client 101 may issue a machine learning model inference request and wait for the results. However, for subsequent requests, rather than waiting for a machine learning model inference result, client 101 may instead use a fast prediction approach, such as k-nearest neighbours, to determine if machine learning service 104 has already returned a result for a set of input features that are ‘close enough’ to the new request. Here, the inference results from the closest neighbour may be returned. Optionally, to improve long-term results of the system, client 101 may send an asynchronous request to machine learning model service interface 107 with the new input features, however it does not need to wait for results—any asynchronous machine learning model inference results can be retrieved at a future point in time (e.g., at the next time an inference result is needed), or may be handled by an asynchronous task processor (not shown in FIG. 1). Over time, client 101 may have a larger number of machine learning model inference results in cache 117, thus improving the quality of the ‘nearest neighbour’ predictions.

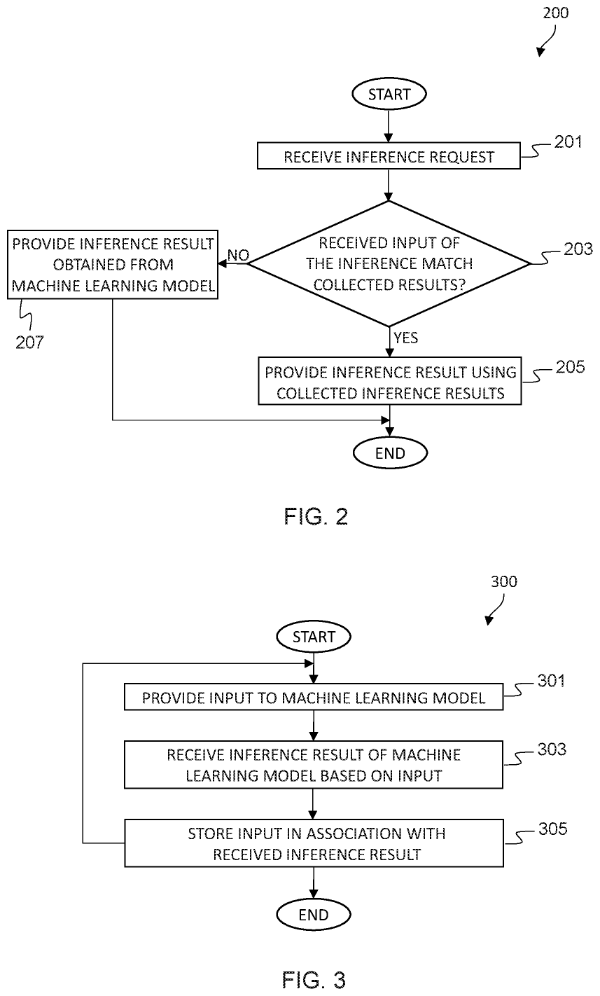

FIG. 2 depicts flowchart 200, a method for inference of a machine learning model in accordance with an embodiment of the present invention. For the purpose of explanation, the method described in FIG. 2 may be implemented in the system illustrated in FIG. 1; however, the method is not limited to this implementation. The method of FIG. 2 may, for example, be performed by client 101 of computer system 100.

An inference request may be received in step 201 by computer application 103. The inference request may comprise an input such as input data 112. The input of the inference request may, for example, include an input format. Optionally, the inference request may include an indication of a specific machine learning model of machine learning model 111-N. This indication may be advantageous as it may help to quickly identify the machine learning model that needs to be used for inference. The inference request may further indicate one or more parameters that may be used by machine learning model 111-N to perform the inference, or machine learning parameters to be used for a particular machine learning model.

It may be determined, in decision step 203, whether the input of the inference request has a match in the collected inputs stored to cache 117. For example, it may be determined in decision step 203 whether the input of the inference request matches at least one of the collected inputs. The collected inputs may be stored in cache 117 as described with reference to FIG. 1. The matching may be an exact match or approximate match.

In a first example, a nearest neighbor search for the input of the inference request may be performed within the collected inputs. The nearest neighbor search may search for the K closest collected inputs (or most similar) to the input of the inference request, where K≥1 In addition, the distance of each of the K closest collected inputs to the request input may be compared to a threshold value, resulting in J closest collected inputs having a distance less than the threshold value, where 0≤J≤K. It may be determined that the input of the inference request has a match if at least one of the K closest collected inputs has a distance smaller than the threshold value (i.e., if J≥1). If the number of searched closest inputs that have a distance smaller than the threshold value is higher than one (i.e., J>1), the matching may further comprise combining the inference results associated with the identified J closest collected inputs. The combination may, for example, comprise averaging, or other forms of combination, depending on the output of the machine leaning model. The combined result may be provided as inference result 115 of the received input data 112. In another example, the closest one of the J closest collected inputs may be selected, and the associated inference result may be used as a result for the received input. The nearest neighbor search may, for example, be performed by the k-nearest neighbors' algorithm.

In a second example, a distance, such as Euclidean distance, may be computed between the input of the inference request and each collected input of the collected inputs. The K collected inputs associated with the K smallest distances may be selected, wherein the K smallest distances are less than a threshold value. If no K smallest distances which are less than the threshold value can be found, then there is no match for the received input. The inference result of the input of the inference request may be determined from the K inference results associated with the K collected inputs as described with reference to the first example.

When the input of the inference request has a match, an inference result may be provided without using the machine learning model in step 205. If the number of searched closest points is one (e.g., K=1), the provided inference result in step 205 may be the previously collected inference result associated with the collected input that is determined as matching the received input. If the number of searched closest points is greater than one (e.g., K>1), the collected inference results associated with the K collected inputs that are determined as matching the received input, may be combined, wherein the provided result in step 205 is the combined result. The combination may, for example, be an average or a weighted sum.

When the input of the inference request has no match in the collected inputs, an inference result may be obtained in step 207 from machine learning model 111-N by providing the input of the inference request to said machine learning model. In one embodiment, client 101 may send input data 112 using a REST operator to machine learning service 104 in order to process the machine learning model using the provided input and to receive inference result 115 of machine learning model 111-N from machine learning service 104 via the REST API.

FIG. 3 depicts flowchart 300, a method for collecting inference results of a machine learning model in accordance with an embodiment of the present invention. For the purpose of explanation, the method described in FIG. 3 may be implemented in the system illustrated in FIG. 1; however, the method is not limited to this implementation. The method of FIG. 3 may, for example, be performed by client 101 of computer system 100.

An input may be provided in step 301 to the machine learning model. If for example, the machine learning model is part of client 101, the input may be input to the machine learning model 111-N in step 301. If the machine learning model is provided as a remote service as indicated in FIG. 1, the input may be sent as part of a request (e.g., a REST operator), to machine learning service 104.

In one embodiment, the method of FIG. 3 may be executed offline (i.e., independent of the method of FIG. 2). In another embodiment, the method of FIG. 3 may dynamically be executed while the method of FIG. 2 is also executing. In this embodiment, step 301, step 303, and step 305 may, for example, be part of step 207 of FIG. 2. That is, if there is no match found in FIG. 2 for a received inference request, the inference result may be obtained using a machine learning model (e.g., machine learning model 111-N) and collected. In another embodiment, step 301, step 303, and step 305 may be performed after (e.g. asynchronously) executing step 205 of FIG. 2 if the matching determined in step 203 of FIG. 2 is not an exact match.

In response to providing the input in step 301, an inference result may be obtained from the machine learning model in step 303. The machine learning model may process the input of step 301 in order to provide the inference result of step 303.

Both the input of step 301 and the associated inference result obtained in step 303 may be stored in step 305 in a storage device. In one embodiment, the storage device may be cache 117 of client 101 in computing system 100.

As indicated in FIG. 3, step 301, step 303, and step 305 may, for example, be repeated for each received input of the machine learning model. Thus, the method of FIG. 3 may enable the collection of inference results and associated inputs dynamically. The collected inputs and inference results may, for example, be used in FIG. 2.

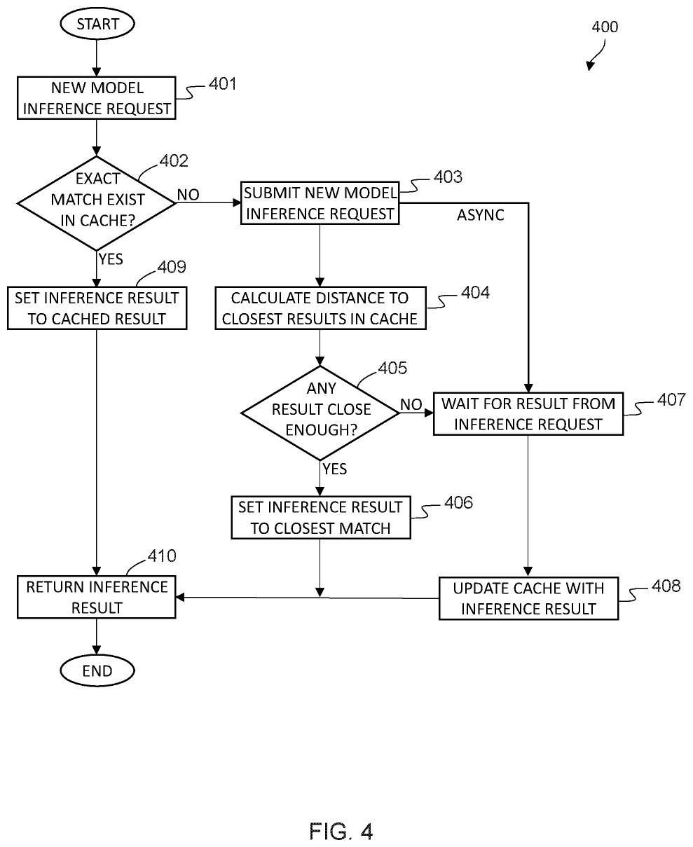

FIG. 4 depicts flowchart 400, a method for inference of a machine learning model, in accordance with an embodiment of the present invention. For the purpose of explanation, the method described in FIG. 4 may be implemented in the system illustrated in FIG. 1; the method is not limited to this implementation. The method of FIG. 4 may, for example, be performed by client 101 of computer system 100.

In step 401, a new model inference request is received. The inference request may include a model input of the machine learning model. It may be determined in decision step 402 whether there is an exact match of the received model input in memory (e.g., cache 117 of FIG. 1) where previously collected inference results and associated inputs of the machine learning model are stored.

If there is an exact match of the model input determined in decision step 402, the inference result of the model input is provided in step 409 and the provided inference result is the cached inference result associated with the exact matching input stored in the cache.

If there is no exact match, the new model inference request is submitted asynchronously in step 403 to the machine learning model. A distance to the closest inference results in the cache is calculated in step 404. The distance to closest inference results may be the distance between the model input and the cached inputs associated with said closest inference results respectively. In decision step 405, a determination is made whether at least one inference result is close enough, said inference result may be provided as the inference result of the model input. “At least one inference result is close enough” means that the distance between the model input and at least one cached input is less than a threshold, wherein the at least one inference result that is close enough is the at least one inference result that is cached in association with said at least one cached input. In decision step 405, if no inference result is close enough, then the inference result that was asynchronously requested may be used (i.e., the result is waited for in step 407. In step 408, the cache is updated with the inference result of the asynchronous request. The inference result obtained in step 406, step 408, and step 409 is returned in step 410 as a response to the received inference model request.

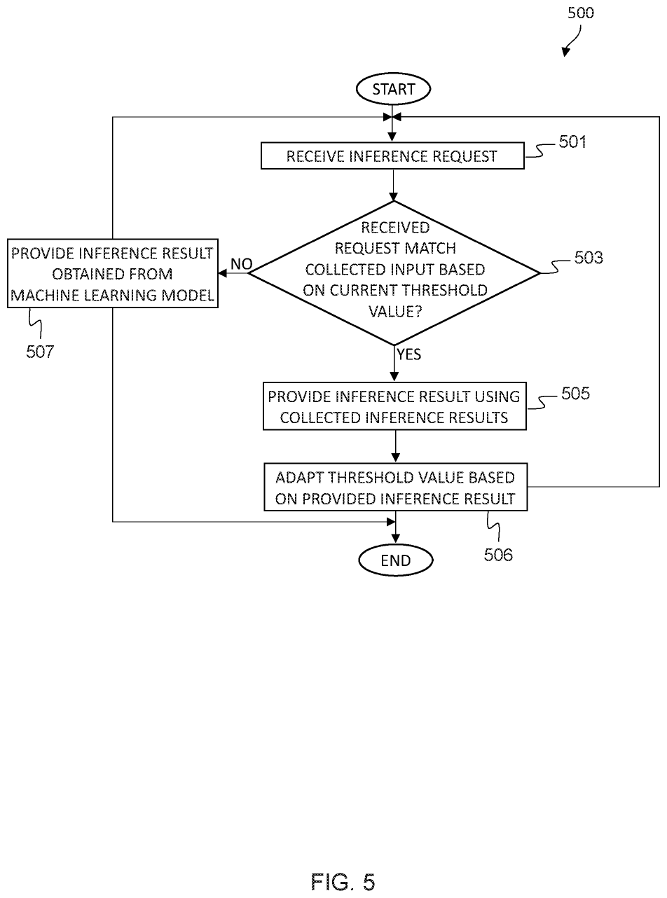

FIG. 5 depicts flowchart 500, a method for inference of a machine learning model, in accordance with an embodiment of the present invention. For the purpose of explanation, the method described in FIG. 5 may be implemented in the system illustrated in FIG. 1; however, the method is not limited to this implementation. The method of FIG. 5 may, for example, be performed by client 101 of computing system 100.

An inference request is received in step 501 by computer application 103. The inference request may comprise an input such as input data 112. It may be determined, in decision step 503 (as described with reference to step 203), whether the input of the inference request has a match in the collected inputs stored in cache 116. As described with reference to step 203, the matching may be performed using the threshold value. In response to the input of the inference request having a match, an inference result is provided in step 505 without using the machine learning model (as described with reference to step 205). In step 506, the threshold value is changed (i.e., updated) based on the provided inference result. The changed threshold value may become the current threshold value which may be used in a next iteration of the method. This may, for example, be performed by asynchronously obtaining the inference result from the machine learning model. The difference between the obtained inference result and determined inference result of step 505 may be used to adjust or adapt the threshold value. For example, if a small difference (i.e., distance) between the request input and the matching collected input translates to a large difference between the determined inference results and the obtained inference results, the threshold value may be decreased. If a large difference between the request input and the matching collected input results in a very small difference between the determined inference results and the obtained inference results, the threshold value may be increased. If the input of the inference request has no matches in the collected inputs, an inference result may be obtained in step 507 (as described with reference to step 207) from the machine learning model by providing the input of the inference request to the machine learning model.

The method of FIG. 5 may be repeated for each further received inference request, wherein with each repetition, the current threshold value (i.e., the last changed value) is used in decision step 503.

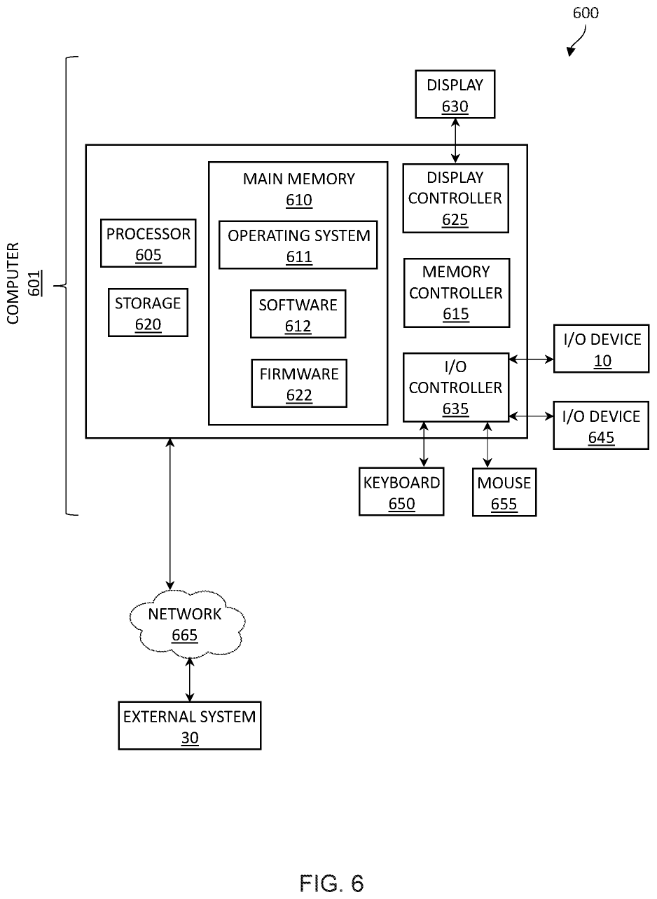

FIG. 6 depicts system 600, a general computerized system suited for implementing at least part of method steps as involved in the present invention.

It will be appreciated that the methods described herein are at least partly non-interactive, and automated by way of computerized systems, such as servers or embedded systems. In exemplary embodiments, the methods described herein can be implemented in a (partly) interactive system. These methods can further be implemented in software 612, firmware 622, processor 605, or a combination thereof. In exemplary embodiments, the methods described herein are implemented in software, as an executable program, and are executed by a special or general-purpose digital computer, such as a personal computer, workstation, minicomputer, or mainframe computer. The most general system 600 therefore includes computer 601.

In exemplary embodiments, in terms of hardware architecture, as shown in FIG. 6, computer 601 includes processor 605 and main memory 610 coupled to memory controller 615, and one or more input and/or output (I/O) devices such as I/O device 10 and I/O device 645 that are communicatively coupled via input/output controller 635. Input/output controller 635 can be, but is not limited to, one or more buses or other wired or wireless connections, as is known in the art. Input/output controller 635 may have additional elements, which are omitted for simplicity, such as controllers, buffers (caches), drivers, repeaters, and receivers, to enable communications. Further, the local interface may include address, control, and/or data connections to enable appropriate communications among the aforementioned components. As described herein, I/O device 10 and I/O device 645 may generally include any generalized cryptographic card or smart card known as known in the art.

Processor 605 is a hardware device for executing software, particularly software stored to main memory 610. Processor 605 can be any custom made or commercially available processor, a central processing unit (CPU), an auxiliary processor among several processors associated with computer 601, a semiconductor-based microprocessor (in the form of a microchip or chip set), or generally any device for executing software instructions.

Main memory 610 can include any one of or combination of volatile memory elements (e.g., random access memory (RAM, such as Direct RAM (DRAM), Static RAM (SRAM), Synchronous Dynamic RAM (SDRAM), etc.)) and nonvolatile memory elements (e.g., read-only memory (ROM), erasable programmable read-only memory (EPROM), electronically erasable programmable read-only memory (EEPROM), and programmable read-only memory (PROM). Note that main memory 610 can have a distributed architecture, where various components are situated remote from one another, but can be accessed by processor 605.

The software in main memory 610 may include one or more separate programs, each of which comprises an ordered listing of executable instructions for implementing logical functions, notably functions involved in embodiments of the present invention. In the example of FIG. 6, software in main memory 610 includes software 612 which includes instructions to manage databases such as a database management system.

The software in main memory 610 also includes a suitable operating system (OS) such as OS 611. OS 611 controls the execution of other computer programs, such as software 612 and firmware 622 for implementing methods as described herein.

Software 612 may be comprised of a source program, an executable program (i.e., object code), a script, or any other entity comprising a set of instructions to be performed. When software 612 includes a source program, said source program needs to be translated via a compiler, assembler, interpreter, or the like, which may or may not be included within main memory 610, so as to operate properly in connection with OS 611. Furthermore, the methods can be written as an object-oriented programming language, which has classes of data and methods, or as a procedure programming language, which has routines, subroutines, and/or functions.

In exemplary embodiments, keyboard 650 and mouse 655 can be coupled to input/output controller 635. Other output devices such as the I/O device 645 may include input devices, for example but not limited to a printer, a scanner, microphone, and the like. The I/O device 10 and I/O device 645 may further include devices that communicate both inputs and outputs, for instance, but not limited to, a network interface card (NIC) or modulator/demodulator (for accessing other files, devices, systems, or a network), a radio frequency (RF) or other transceiver, a telephonic interface, a bridge, a router, and the like. I/O device 10 and I/O device 645 can be any generalized cryptographic card or smart card known in the art. System 600 can further include display controller 625 coupled to display 630. In exemplary embodiments, system 600 can further include a network interface for coupling to a network such as network 665. Network 665 can be an Internet Protocol (IP) based network for communication between computer 601 and any external server, client, and the like via a broadband connection. Network 665 transmits and receives data between computer 601 and external system 30, which can be involved to perform part, or all of the steps of the methods discussed herein. In exemplary embodiments, network 665 can be a managed IP network administered by a service provider. Network 665 may be implemented in a wireless fashion using wireless protocols and technologies, such as wireless fidelity (WiFi), Worldwide Interoperability for Microwave Access (WiMax), etc. Network 665 can also be a packet-switched network such as a local area network, wide area network, metropolitan area network, Internet network, or other similar type of network environment. Network 665 may be a fixed wireless network, a wireless local area network (WLAN), a wireless wide area network (WWAN), a personal area network (PAN), a virtual private network (VPN), an intranet, or other suitable network system, and includes equipment for receiving and transmitting signals.

If computer 601 is a personal computer (PC), workstation, intelligent device, or the like, the software in main memory 610 may further include a basic input output system or BIOS (not shown in FIG. 1). The BIOS is a set of essential software routines that initialize and test hardware at startup, start OS 611, and support the transfer of data among the various hardware devices. The BIOS is stored in ROM so that the BIOS can be executed when computer 601 is activated.

When computer 601 is in operation, processor 605 is configured to execute software 612 stored within main memory 610, to communicate data to and from main memory 610, and to generally control operations of computer 601 pursuant to the software. The methods described herein and OS 611, in whole or in part are read by processor 605, possibly buffered within processor 605, and then executed.

When the systems and methods described herein are implemented in software 612, as is shown in FIG. 6, the methods can be stored on any computer readable medium, such as storage 620, for use by or in connection with any computer related system or method. Storage 620 may be a disk storage such as hard disk drive (HDD) storage.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

What is claimed is:

1. A computer implemented method, the computer implemented method comprising:
collecting inference results of a machine learning model and associated inputs;
receiving an inference request;
determining whether a request input of the inference request matches at least one collected input in a set of collected inputs; and
responsive to determining that the request input matches at least one collected input in the set of collected inputs, determining an inference result using one or more collected inference results associated with the at least one collected input in the set of collected inputs.

2. The method of claim 1, wherein responsive to the request input not matching at least one collected input in the set of collected inputs, asynchronously obtaining the inference result from the machine learning model by inputting the request input to the machine learning model;
updating the set of collected inputs by adding an obtained inference result and the request input to the set of collected inputs, wherein the set of collected inputs includes associated inference results; and
using the updated set of collected inputs and associated inference results for a subsequent received inference request.

3. The method of claim 2, wherein the obtained inference result is obtained by a dedicated asynchronous task processor which is distinct from a processor performing an inference assessment.

4. The method of claim 1, wherein responsive to the request input not matching at least one collected input in the set of collected inputs, adding an obtained inference result from the machine learning model to a set of collected inference results in association with the request input.

5. The method of claim 1, wherein the determining whether the request input matches at least one collected input in the set of collected inputs comprises:
computing a distance between the request input and each collected input in the set of collected inputs; and
responsive to a first distance of the computed distances being less than a threshold value, the request input matches a collected input with the first distance to the request input.

6. The method of claim 1, further comprising:
providing an algorithm, the algorithm being configured to receive as input the set of collected inputs and the received input request;
the algorithm further configured to identify K closest collected inputs of the request input using the provided algorithm; and
wherein determining that the request input matches at least one collected input in the set of collected inputs comprises:
responsive to a distance of J closest collected inputs of the identified K closest collected inputs to the request input is less than a threshold value, determining that there is a match between the request input and at least one collected input in the set of collected inputs; and
responsive to determining that there is no matching, where J≤K, determining the inference result of the request input comprises selecting one of the J collected inference results associated with the J closest collected inputs or combining the J collected inference results.

7. The method of claim 6, wherein the algorithm is one of a k-Nearest Neighbors algorithm or k-means algorithm.

8. The method of claim 6, further comprising:
asynchronously obtaining an inference result of the request input from the machine learning model;
dynamically changing the threshold value based on a difference between the determined inference result and the asynchronously obtained inference result; and
using the dynamically changed threshold value for determining an inference result of a further received inference request.

9. The method of claim 8, wherein changing the threshold value comprises one of increasing and decreasing the threshold value.

10. The method of claim 1, wherein collecting the inference results is performed such that a minimum number of inference results is collected.

11. The method of claim 10, wherein the minimum number of inference results is one.

12. The method of claim 1, wherein collecting inference results of the machine learning model and associated inputs comprises storing the collected inference results of the machine learning model and associated inputs in a cache.

13. The method of claim 1, wherein:
the machine learning model is provided as a service; and
obtaining an inference result comprises communicating the request input to the machine learning model via an interface and receiving the inference result via the interface.

14. The method of claim 1, wherein determining whether the request input matches at least one collected input in the set of collected inputs comprises determining whether the request input approximately matches the at least one collected input in the set of collected inputs.

15. The method of claim 1, wherein determining whether the request input matches at least one collected input in the set of collected inputs, comprises:
providing an upper threshold value and a lower threshold value;
computing a distance between the request input and the collected inputs; and
responsive to a first distance of the computed distances being less than or equal to the lower threshold value, determining that the request input matches exactly the collected input having said distance to the request input.

16. The method of claim 15, further comprising:
responsive to determining that the request input has a data format different from the data format of the collected inputs, transforming the data format of the request input into the data format of the collected inputs, wherein:
a comparison is performed between the transformed request input and the collected inputs for determining if the request input matches at least one collected input in the set of collected inputs; and
the lower threshold value is a transformation error indicative of a difference between the transformed request input and the request input.

17. The method of claim 16, wherein:
the data format is a number format;
the transformation is performed by rounding the request input; and
the transformation error is a rounding error.

18. A computer program product, the computer program product comprising:
one or more computer readable storage media; and
program instructions stored on the one or more computer readable storage media, the program instructions comprising:
program instructions to implement the method of claim 1.

19. A computer system, the computer system comprising:
one or more computer processors;
one or more computer readable storage media; and
program instructions stored on the one or more computer readable storage media for execution by at least one of the one or more computer processors, the program instructions comprising:
program instructions to collect inference results of a machine learning model and associated inputs;
program instructions to receive an inference request;
program instructions to determine if a request input of the inference request matches at least one collected input of the collected inputs; and
responsive to the request input having one or more matching collected inputs in the collected inputs, determining an inference result using one or more collected inference results associated with said one or more matching collected inputs.

20. The computer system of claim 19, wherein:
responsive to the request input not matching at least one collected input in the set of collected inputs, asynchronously obtaining the inference result from the machine learning model by inputting the request input to the machine learning model;
updating the set of collected inputs by adding an obtained inference result and the request input to the set of collected inputs, wherein the set of collected inputs includes associated inference results; and
using the updated set of collected inputs and associated inference results for a subsequent received inference request.
